(19) United States
(12) Patent Application Publication
(10) Pub. No.: US 2017/0358988 A1
(43) Pub. Date: Dec. 14, 2017

(54) SWITCHED-MODE POWER SUPPLY

(71) Applicant: SALCOMP OYJ, Salo (FI)

(72) Inventors: Jukka VAARAPURO, Teijo (FI); Jari ANTTILA, Turku (FI)

(73) Assignee: SALCOMP OYJ, Salo (FI)

(21) Appl. No.: 15/537,153

(22) PCT Filed: Dec. 11, 2015
(86) PCT No.: PCT/FI2015/050872

§ 371 Date: Jun. 16, 2017

(30) Foreign Application Priority Data
Dec. 17, 2014 (FI) 20146108

(51) Int. Cl. H02M 3/335; H02M 7/12; H02M 1/00

(52) U.S. Cl. CPC H02M 3/33507; H02M 7/125; H02M 2001/0035

(57) ABSTRACT

The present invention relates to a switched-mode power supply that comprises a detection circuit for detecting a coupling of an electrical device to the switched-mode power supply and a decoupling of the electrical device from the switched-mode power supply, a switch for controlling the supply of electric power to the switched-mode power supply, a control circuit for controlling the switch, the control circuit being configured to turn on the switch when the coupling of the electrical device has been detected, and to turn off the switch when the decoupling of the electrical device has been detected, and a supply circuit for providing a supply voltage to the detection circuit and the control circuit.

### TECHNICAL FIELD OF THE INVENTION

The present invention relates to a switched-mode power supply according to the preamble of the appended independent claim.

### BACKGROUND OF THE INVENTION

Switched-mode power supplies (SMPS) are widely used in many applications, such as battery chargers. A switched-mode power supply is chosen for an application because its weight, efficiency, size and/or wide input range tolerance make it preferable in comparison to a linear power supply.

FIG. 1 illustrates the known principle of a switched-mode power supply. The power supply comprises a primary side 101 and a secondary side 102, which are linked together through a transformer 103. An AC input to the primary side 101 is rectified in a rectifier 104. A reservoir capacitor 105 serves as a filter at the rectifier output. The primary current through a primary winding 106 of the transformer 103 is regularly chopped with a primary switch 107 that is driven by an oscillator circuit 108. Intercepting the current in the primary winding 106 causes the energy that was temporarily stored in the magnetic field of the transformer 103 to discharge in the form of a current through a secondary winding 109 of the transformer 103. A diode 110 on the secondary side 102 rectifies the secondary current and causes a secondary voltage to be maintained across a reservoir capacitor 111. The secondary voltage acts as the DC output voltage of the power supply.

A switched-mode power supply operates at a high efficiency. With an optimized design, the efficiency of a switched-mode power supply can be over 90%. Even though the efficiency is a crucial factor when considering the total energy loss of a power supply, there is also another factor that should be taken into account, namely the standby power, i.e. the energy that the power supply consumes in the standby state. Main reasons for the energy loss of a switched-mode power supply in the standby state are the leakage current of the capacitor(s) and the current drawn by the integrated circuit(s).

Some techniques are known in the prior art for reducing the energy consumption of a switched-mode power supply in the standby state. A main disadvantage of the known techniques is that they are inefficient. With the known techniques, it is difficult, or even impossible, to achieve a standby power of less than 10 mW. Another disadvantage of the known techniques is that they are complicated and expensive to manufacture.

### OBJECTIVES OF THE INVENTION

It is the main objective of the present invention to reduce or even eliminate prior art problems presented above.

It is an objective of the present invention to minimise the energy consumption of a switched-mode power supply in the standby state. It is also an objective of the invention to provide a switched-mode power supply that can efficiently switch between the active state and the standby state of the power supply.

In order to realise the above-mentioned objectives, the switched-mode power supply according to the invention is characterised by what is presented in the characterising portion of the appended independent claim. Advantageous embodiments of the invention are described in the dependent claims.

### DESCRIPTION OF THE INVENTION

A typical switched-mode power supply according to the invention comprises a primary side, a secondary side, and a transformer between the primary side and the secondary side. The typical switched-mode power supply according to the invention further comprises a detection circuit for detecting a coupling of an electrical device to the switched-mode power supply and a decoupling of the electrical device from the switched-mode power supply, a switch for controlling the supply of electric power to the switched-mode power supply, a control circuit for controlling the switch, the control circuit being configured to turn on the switch when the coupling of the electrical device has been detected, and to turn off the switch when the decoupling of the electrical device has been detected, and a supply circuit for providing a supply voltage to the detection circuit and the control circuit. In the typical switched-mode power supply according to the invention the supply circuit comprises a rectifier having two input and two output terminals, the input terminals being coupled by interference suppression capacitors to the input terminals of the switched-mode power supply, and a charging capacitor coupled between the output terminals of the rectifier for storing an electric energy to operate the detection circuit and the control circuit.

The switched-mode power supply according to the invention can operate in an active state and a standby state. In the active state, the switch is in the conducting state (i.e. ON state) and the primary current through a primary winding of the transformer is regularly chopped with a primary switch, as a result of which the energy that was temporarily stored in the magnetic field of the transformer discharges in the form of a current through a secondary winding of the transformer. The secondary current is rectified and then supplied to an electrical device that is coupled to the output of the power supply. In the standby state, the switch and the primary switch are in the non-conducting state (i.e. OFF state), so that electric energy is not transferred through the transformer to the secondary side of the power supply.

In the switched-mode power supply according to the invention the determination of whether the power supply should operate in the active state or the standby state is based on whether or not an electrical device is coupled to the output of the power supply. The detection circuit that is provided on the secondary side of the power supply is configured to detect both the coupling and the decoupling of the electrical device.

The switch is located on the primary side of the power supply, between a mains connection (input terminals) and a first reservoir capacitor so that the leakage current of the capacitor(s) on the primary side can be minimised. The switch that controls the supply of electric power from the mains to the primary side is controlled by the control circuit that is configured to turn on the switch when the coupling of the electrical device has been detected, and to turn off the switch when the decoupling of the electrical device has been detected. In other words, the switch is in the conducting state when an electrical device is coupled to the output of the power supply and in the non-conducting state when no electrical device is coupled to the output of the power supply. The control circuit is connected to the detection circuit in order to receive the information regarding the coupling and the decoupling of the electrical device.

The supply circuit that is located on the secondary side of the power supply is connected to the detection circuit and the control circuit. A purpose of the supply circuit is to provide the supply voltage to the detection circuit and the control circuit when the power supply operates in the standby state. The supply circuit is necessary because in the standby state electric energy is not transferred through the transformer to the secondary side of the power supply. The supply circuit is coupled by interference suppression capacitors to the input terminals of the switched-mode power supply in order to receive electric energy from the mains regardless of the state of the switch. Because the supply circuit is coupled through the interference suppression capacitors to the input of the power supply, electric energy can be obtained from the mains and stored to the charging capacitor regardless of the state of the switch. When the power supply operates in the active state the supply voltage to the detection circuit and the control circuit can be provided by the supply circuit or it can be obtained from the secondary side of the switched-mode power supply, for example from the output of the power supply.

The rectifier converts an AC input into a DC output. The rectifier is preferably a bridge rectifier that comprises four (or more) diodes in a bridge circuit configuration that provides full-wave rectification from the AC input. The interference suppression capacitors have preferably low capacitance values and are preferably Y1 class capacitors, which can be used with voltages up to 500 VAC. The use of Y1 class capacitors ensures that the secondary side of the power supply is galvanically separated from the mains. The total capacitance value of the interference suppression capacitors is preferably so small that the leakage current from the interference suppression capacitors stays under 0.25 mA.

An advantage of the switched-mode power supply according to the invention is that its energy consumption is minimal in the standby state. The reason for this is that in the standby state the primary side of the power supply is disconnected from the mains with the switch. With the present invention, it is possible to achieve a standby power of less than 1 mW, or even less than 0.2 mW.

Another advantage of the switched-mode power supply according to the invention is that it can efficiently switch between the active state and the standby state.

Still another advantage of the switched-mode power supply according to the invention is that it can be in the active state only when an electrical device is coupled to the output of the power supply.

The switched-mode power supply according to the invention can be applied, for example, in a battery charger that is used for charging a battery of an electrical device, such as a mobile phone or a portable computer.

According to an embodiment of the invention the supply circuit comprises a zener diode connected in parallel with the charging capacitor for limiting the maximum voltage of the charging capacitor. The anode of the zener diode is connected to the negative terminal of the charging capacitor, and the cathode of the zener diode is connected to the positive terminal of the charging capacitor. The maximum voltage of the charging capacitor is determined based on the zener voltage of the zener diode. The zener voltage must be chosen so high that the electric energy provided by the charging capacitor is high enough for the detection circuit and the control circuit to operate.

According to an embodiment of the invention the positive output terminal of the switched-mode power supply is connected through a diode to the positive terminal of the charging capacitor in order to provide a supply voltage to the detection circuit and the control circuit during an active state of the switched-mode power supply. The cathode of the diode is connected to the positive terminal of the charging capacitor.

According to an embodiment of the invention the switched-mode power supply comprises a USB interface having interconnected D+ and D− data lines, through which USB interface electric power is to be supplied to the electrical device, and the detection circuit is configured to detect the coupling and the decoupling of the electrical device based on a voltage at the interconnected D+ and D− data lines. The detection of the coupling and the decoupling of the electrical device using the interconnected D+ and D− data lines is possible because the voltage level at these data lines is different depending on whether the electrical device is coupled to the power supply or not.

According to an embodiment of the invention the detection circuit comprises a first bipolar transistor, the base of which is connected through a first resistor to the interconnected D+ and D− data lines. When an electrical device is coupled to the power supply, the first resistor is connected through pull-down resistors of the D+ and D− data lines to the ground. As a result of this the first bipolar transistor, the emitter of which is connected to the positive terminal of the charging capacitor, becomes conducting and the voltage at the collector rises. When the electrical device is decoupled from the power supply, the first bipolar transistor switches into a non-conducting state and the voltage at the collector decreases. The collector of the first bipolar transistor is connected to the control circuit providing information of the coupling and the decoupling of an electrical device. The resistance of the first resistor must be so high that the impedance from the interconnected D+ and D− data lines to the detection circuit is higher than the minimum impedance value specified in the USB standard.

According to an embodiment of the invention the emitter of the first bipolar transistor is connected to the positive terminal of the charging capacitor.

According to an embodiment of the invention the control circuit comprises an opto-triac comprising a light emitting diode at its input side and a photosensitive triac at its output side, the photosensitive triac being connected to the switch, and a field-effect transistor connected to the light emitting diode for controlling the current flow through the light emitting diode.

The field-effect transistor controls the operation of the opto-triac. When an electrical device is coupled to the power supply, the field-effect transistor becomes conducting and current starts to flow through the light-emitting diode. The light-emitting diode triggers the photosensitive triac into a conducting state, as a result of which the switch is turned into a conducting state. The photosensitive triac is connected to a control terminal of the switch. Once triggered, the photosensitive triac continues to conduct until the current drops below the holding current. The opto-triac separates galvanically the primary side from the secondary side.

According to an embodiment of the invention the anode of the light emitting diode is connected to the positive terminal of the charging capacitor, and the cathode of the light emitting diode is connected through a second resistor to the drain of the field-effect transistor.

According to an embodiment of the invention the control circuit comprises a second bipolar transistor for switching the field-effect transistor, the collector of the second bipolar transistor being connected to the gate of the field-effect transistor, and the emitter of the second bipolar transistor being connected through a third resistor to the collector of the first bipolar transistor.

The second bipolar transistor is used to prevent the field-effect transistor from conducting in cases where the supply voltage provided by the supply circuit is so low that the light-emitting diode cannot trigger the photosensitive triac into a conducting state. This could happen, for example, when an electrical device is coupled to the switched-mode power supply before the power supply is connected to the mains.

According to an embodiment of the invention the switch is connected between an input terminal of the switched-mode power supply and an input terminal of a rectifier of the switched-mode power supply. Preferably, the switch is a triac.

According to an embodiment of the invention the switch is connected between an output terminal of a rectifier of the switched-mode power supply and a terminal of a reservoir capacitor of the switched-mode power supply. Preferably, the switch is a thyristor. The thyristor is a bistable switch that becomes conducting when its gate receives a current trigger, and continues to conduct while being forward biased. Other alternatives for the switch are a metal-oxide semiconductor field-effect transistor (MOSFET), a relay or an insulated gate bipolar transistor (IGBT).

The exemplary embodiments presented in this text are not interpreted to pose limitations to the applicability of the appended claims. The verb “to comprise” is used in this text as an open limitation that does not exclude the existence of also unrecited features. The features recited in the dependent claims are mutually freely combinable unless otherwise explicitly stated. Advantages presented in this text relate by applicable parts to different embodiments, even though this is not always separately mentioned.

### BRIEF DESCRIPTION OF THE DRAWINGS

FIG. 1 illustrates the known principle of a switched-mode power supply,

FIG. 2 illustrates a switched-mode power supply according to a first embodiment of the invention, and

FIG. 3 illustrates a switched-mode power supply according to a second embodiment of the invention.

### DETAILED DESCRIPTION OF THE DRAWINGS

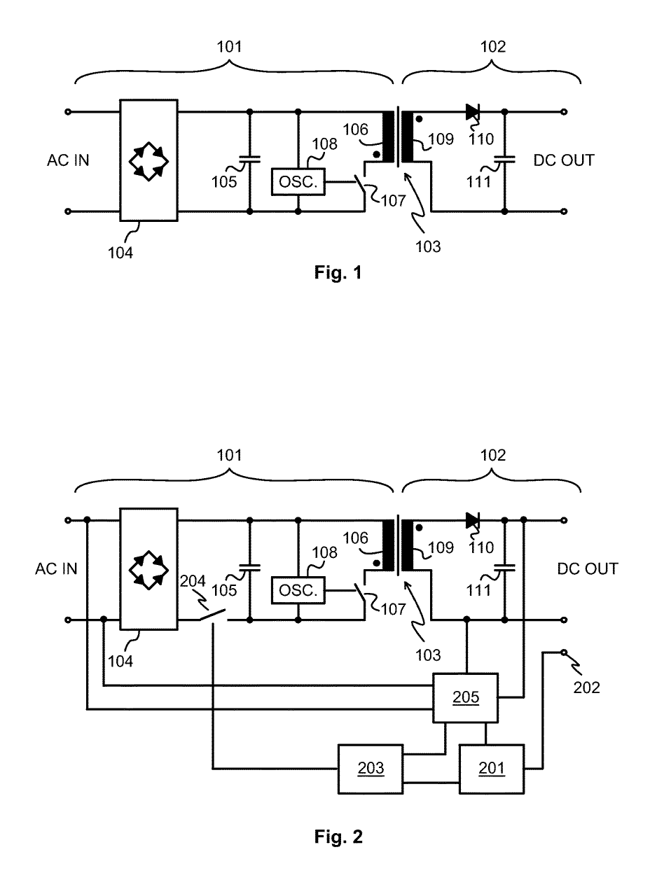

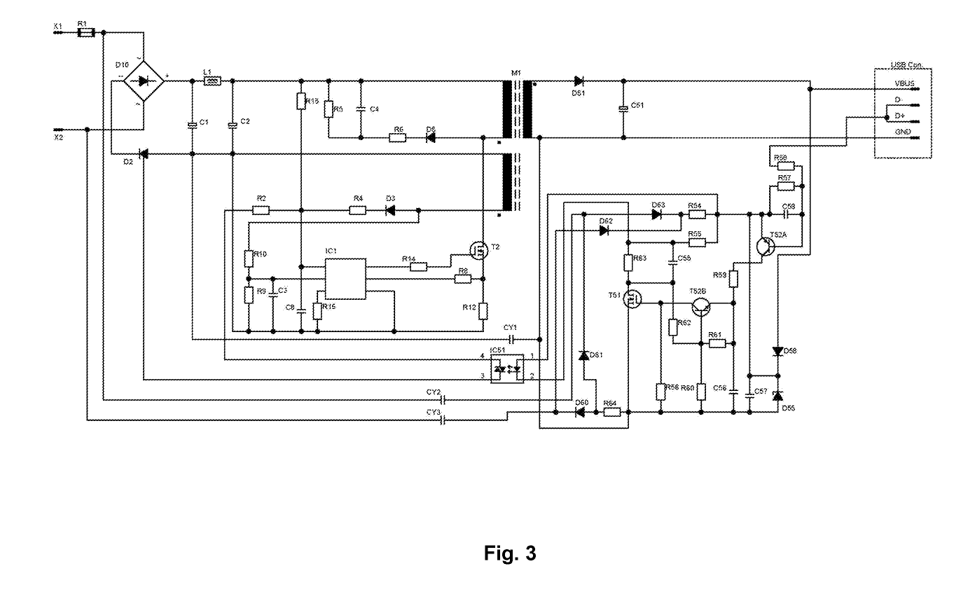

Embodiments of the invention will now be described with reference to FIGS. 2 and 3.

FIG. 2 illustrates a switched-mode power supply according to a first embodiment of the invention. As in FIG. 1, the power supply comprises a primary side 101 and a secondary side 102, which are linked together through a transformer 103 having a primary winding 106 and a secondary winding 109. An AC input to the primary side 101 is rectified in a rectifier 104, the output of which is smoothed by a reservoir capacitor 105. The primary current through the primary winding 106 is regularly chopped with a primary switch 107 that is driven by an oscillator circuit 108. Intercepting the current in the primary winding 106 causes the energy that was temporarily stored in the magnetic field of the transformer 103 to discharge in the form of a current through the secondary winding 109. A diode 110 on the secondary side 102 rectifies the secondary current and causes a secondary voltage to be maintained across a reservoir capacitor 111.

The switched-mode power supply of FIG. 2 comprises a detection circuit 201 for detecting whether or not an electrical device (not shown) is coupled to the output of the power supply. The coupling/decoupling of the electrical device is determined depending upon a voltage applied at a detection terminal 202 to which the electrical device is connected when the electrical device is coupled to the power supply. The detection circuit is connected to a control circuit 203 that controls, based on the coupling information, a switch 204 that is located on the primary side 101, between an output terminal of the rectifier 104 and one terminal of the reservoir capacitor 105. The switch 204 controls the supply of electric power from the mains to the primary side 101. The control circuit 203 keeps the switch 204 in a conducting state when an electrical device is coupled to the power supply and in a non-conducting state when no electrical device is coupled to the power supply. A supply circuit 205 provides a supply voltage to the detection circuit 201 and the control circuit 203. The supply circuit 205 is coupled to the input terminals of the power supply in order to provide the required supply voltage during the standby state of the power supply. The supply circuit 205 is also coupled to the secondary side of the power supply so that the detection circuit 201 and the control circuit 203 can be supplied with the required supply voltage during the active state of the power supply.

FIG. 3 illustrates a switched-mode power supply according to a second embodiment of the invention. The circuit diagram of FIG. 3 will now be explained focusing on the detection circuit, the switch, the control circuit and the supply circuit.

The supply circuit comprises a bridge rectifier that consists of diodes D60, D61, D62 and D63. The input of the bridge rectifier is coupled through interference suppression capacitors CY2 and CY3 to the input of the power supply. The supply circuit also comprises a charging capacitor C57 for storing an electric energy to operate the detection circuit and the control circuit during the standby state of the power supply. The charging capacitor C57 is connected via resistors R54 and R64 between the output terminals of the bridge rectifier. The maximum voltage of the charging capacitor C57 is limited with a zener diode D55 that is connected in parallel with the charging capacitor C57. The supply circuit further comprises a diode D58 that is connected between the positive output terminal of the power supply and the positive terminal of the charging capacitor C57 so that electrical energy can be provided to the detection circuit and the control circuit during the active state of the power supply.

The switch used in the circuit diagram of FIG. 3 is a thyristor D2 that is connected between the negative output terminal of a rectifier D10 and the negative terminal of a reservoir capacitor C1. The thyristor D2 that controls the supply of electric energy from the mains to the primary side of the power supply is controlled by the control circuit.

The control circuit comprises an opto-triac IC51 having a light emitting diode at its input side and a photosensitive triac at its output side. The output terminal 3 of the opto-triac IC51 is connected to the gate of the thyristor D2. The input terminal 1 of the opto-triac IC51 is connected to the positive terminal of the charging capacitor C57. The control circuit comprises a field-effect transistor T51 that controls the operation of the opto-triac IC51. The drain of the field-effect transistor T51 is connected through a resistor R63 to the input terminal 2 of the opto-triac IC51. The gate of the field-effect transistor T51 is connected to the collector of a bipolar transistor T52B. The bipolar transistor T52B prevents the field-effect transistor T51 from conducting when the supply voltage provided by the charging capacitor C57 is so low that the photosensitive triac of the opto-triac IC51 cannot be triggered into a conducting state. Resistors R60, R61 and R62 are used to define the voltage level at which the bipolar transistor T52B changes its state.

The detection circuit comprises a bipolar transistor T52A, the base of which is connected through a resistor R58 to interconnected D+ and D− data lines of a USB interface. Electric power is to be supplied to an electrical device through the USB interface. The emitter of the bipolar transistor T52A is connected to the positive terminal of the charging capacitor C57, and the collector of the bipolar transistor T52A is connected through a resistor R59 to the emitter of the bipolar transistor T52B.

When an electrical device is coupled to the power supply, the resistor R58 is connected through pull-down resistors of the D+ and D− data lines to the ground. As a result of this the bipolar transistor T52A becomes conducting and its collector voltage rises. Since the collector of the bipolar transistor T52A is connected through the resistor R59 to the emitter of the bipolar transistor T52B, the bipolar transistor T52B becomes conducting and its collector voltage rises so that the field-effect transistor T51 becomes conducting and current starts to flow through the light-emitting diode of the opto-triac IC51. The light-emitting diode triggers the photo-sensitive triac of the opto-triac IC51 into a conducting state, as a result of which the thyristor D2 is turned into a conducting state, whereby the power supply switches into the active state.

When the electrical device is decoupled from the power supply, the base voltage of the bipolar transistor T52A rises. As a result of this the bipolar transistor T52A switches into a non-conducting state. This results in that the gate voltage of the field-effect transistor T51 drops and therefore the field-effect transistor T51 switches into a non-conducting state. As a result of this the thyristor D2 is turned off, whereby the power supply switches into the standby state.

Only advantageous exemplary embodiments of the invention are described in the figures. It is clear to a person skilled in the art that the invention is not restricted only to the examples presented above, but the invention may vary within the limits of the claims presented hereafter. Some possible embodiments of the invention are described in the dependent claims, and they are not to be considered to restrict the scope of protection of the invention as such.

1. A switched-mode power supply, comprising:
a primary side,
a secondary side,
a transformer between the primary side and the secondary side,
a detection circuit for detecting a coupling of an electrical device to the switched-mode power supply and a decoupling of the electrical device from the switched-mode power supply,
a switch for controlling the supply of electric power to the switched-mode power supply,
a control circuit for controlling the switch, the control circuit being configured to turn on the switch when the coupling of the electrical device has been detected, and to turn off the switch when the decoupling of the electrical device has been detected,
a supply circuit for providing a supply voltage to the detection circuit and the control circuit,
a rectifier having two input and two output terminals, the input terminals being coupled by interference suppression capacitors to the input terminals of the switched-mode power supply, and
a charging capacitor coupled between the output terminals of the rectifier for storing an electric energy to operate the detection circuit and the control circuit.

2. The switched-mode power supply according to claim 1, wherein the supply circuit comprises a zener diode connected in parallel with the charging capacitor for limiting the maximum voltage of the charging capacitor.

3. The switched-mode power supply according to claim 1, wherein the positive output terminal of the switched-mode power supply is connected through a diode to the positive terminal of the charging capacitor in order to provide a supply voltage to the detection circuit and the control circuit during an active state of the switched-mode power supply.

4. The switched-mode power supply according to claim 1, wherein:
the switched-mode power supply comprises a USB interface having interconnected D+ and D− data lines, through which USB interface electric power is to be supplied to the electrical device, and
the detection circuit is configured to detect the coupling and the decoupling of the electrical device based on a voltage at the interconnected D+ and D− data lines.

5. The switched-mode power supply according to claim 4, wherein the detection circuit comprises a first bipolar transistor, the base of which is connected through a first resistor to the interconnected D+ and D− data lines.

6. The switched-mode power supply according to claim 5, wherein the emitter of the first bipolar transistor is connected to the positive terminal of the charging capacitor.

7. The switched-mode power supply according to claim 1, wherein the control circuit comprises:
an opto-triac comprising a light emitting diode at its input side and a photosensitive triac at its output side, the photosensitive triac being connected to the switch, and
a field-effect transistor connected to the light emitting diode for controlling the current flow through the light emitting diode.

8. The switched-mode power supply according to claim 7, wherein the anode of the light emitting diode is connected to the positive terminal of the charging capacitor, and the cathode of the light emitting diode is connected through a second resistor to the drain of the field-effect transistor.

9. The switched-mode power supply according to claim 7, wherein the control circuit comprises a second bipolar transistor for switching the field-effect transistor, the collector of the second bipolar transistor being connected to the gate of the field-effect transistor, and the emitter of the second bipolar transistor being connected through a third resistor to the collector of the first bipolar transistor.

10. The switched-mode power supply according to claim 1, wherein the switch is connected between an input terminal of the switched-mode power supply and an input terminal of a rectifier of the switched-mode power supply.

11. The switched-mode power supply according to claim 10, wherein the switch is a triac.

12. The switched-mode power supply according to claim 1, wherein the switch is connected between an output terminal of a rectifier of the switched-mode power supply and a terminal of a reservoir capacitor of the switched-mode power supply.

13. The switched-mode power supply according to claim 12, wherein the switch is a thyristor.
